(19) United States
(12) Patent Application Publication
(10) Pub. No.: US 2026/0074345 A1
(43) Pub. Date: Mar. 12, 2026

(54) BATTERY ASSEMBLY

(71) Applicant: Prime Planet Energy & Solutions, Inc., Tokyo (JP)

(72) Inventor: Shinobu TERAUCHI, Kasai-shi (JP)

(21) Appl. No.: 19/318,371

(22) Filed: Sep. 4, 2025

(30) Foreign Application Priority Data
Sep. 12, 2024 (JP) 2024-158265

(51) Int. Cl. H01M 50/242; H01M 50/209; H01M 50/271; H01M 50/548; H01M 50/55

(52) U.S. Cl. CPC H01M 50/242; H01M 50/209; H01M 50/271; H01M 50/548; H01M 50/55

(57) ABSTRACT

Each of a plurality of battery cells included in a battery assembly includes a case that accommodates an electrode assembly and that has a substantially rectangular shape in which a second direction orthogonal to a first direction corresponds to a long-side direction and a third direction orthogonal to the first direction and the second direction corresponds to a short-side direction when viewed in the first direction. A restraint member includes a pair of members provided to sandwich the plurality of battery cells in the third direction, and the pair of members are fixed to the end plate in the third direction.

### CROSS REFERENCE TO RELATED APPLICATIONS

This nonprovisional application is based on Japanese Patent Application No. 2024-158265 filed on Sep. 12, 2024 with the Japan Patent Office, the entire contents of which are hereby incorporated by reference.

### BACKGROUND OF THE INVENTION

### Field of the Invention

The present technology relates to a battery assembly.

### Description of the Background Art

Conventionally, there has been known a battery assembly in which a plurality of battery cells are arranged along a stacking direction and are restrained in the stacking direction by using an end plate and a restraint member.

Examples of a restraint structure for battery in such a conventional battery assembly include those described in WO 2019/130936 and WO 2019/130937.

### SUMMARY OF THE INVENTION

When expansion force is generated in a battery cell, bending moment acts on the end plate provided at an end portion of the plurality of battery cells. In response to increased size of the battery cell, the end plate is required to have a proof strength sufficient to receive the increased moment load. On the other hand, from the viewpoint of downsizing of the battery assembly, it is required to reduce the thickness of the end plate. From the viewpoint of achieving both these objects, there is still room for improvement in the conventional battery assembly.

An object of the present technology is to provide a battery assembly in which a moment load acting on an end plate is suppressed from being excessively increased.

The present technology provides the following battery assembly.

[1] A battery assembly comprising: a plurality of battery cells arranged in a first direction; an end plate provided at an end portion of the plurality of battery cells in the first direction; and a restraint member that restrains the end plate and the plurality of battery cells in the first direction, wherein each of the plurality of battery cells includes a case that accommodates an electrode assembly and that has a substantially rectangular shape in which a second direction orthogonal to the first direction corresponds to a long-side direction and a third direction orthogonal to the first direction and the second direction corresponds to a short-side direction when viewed in the first direction, the restraint member includes a pair of members provided to sandwich the plurality of battery cells in the third direction, and the pair of members is fixed to the end plate in the third direction.

[2] The battery assembly according to [1], wherein each of the plurality of battery cells has an electrode terminal on a surface of the case orthogonal to the third direction.

[3] The battery assembly according to [1], wherein each of the plurality of battery cells has an electrode terminal on a surface of the case orthogonal to the second direction.

[4] The battery assembly according to any one of [1] to [3], wherein the end plate has a stepped portion on at least one side in the third direction, the battery assembly further comprising a contact plate fixed to the restraint member and in abutment with the stepped portion in the first direction.

[5] The battery assembly according to any one of [1] to [4], wherein each of the pair of members is constituted of a plate-shaped member.

[6] The battery assembly according to any one of [1] to [5], wherein each of the pair of members is provided at a position including a center of the plurality of battery cells in the second direction when viewed in the third direction.

[7] The battery assembly according to any one of [1] to [6], wherein a dimension of each of the pair of members in the second direction is changed along the first direction.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view of a battery included in a battery assembly.

FIG. 2 is a front view showing a battery according to a modification.

FIG. 3 is a perspective view of the battery shown in FIG. 2.

FIG. 4 is a diagram showing a restraint structure for battery in the battery assembly.

FIG. 5 is a diagram for illustrating a load acting on an end plate.

FIG. 6 is a diagram for illustrating a relation between a width (B) and a height (H) of the battery.

FIG. 7 is a diagram showing an exemplary shape of a restraint member in the battery assembly.

### DESCRIPTION OF THE PREFERRED EMBODIMENTS

Hereinafter, embodiments of the present technology will be described. It should be noted that the same or corresponding portions are denoted by the same reference characters, and may not be described repeatedly.

It should be noted that in the embodiments described below, when reference is made to number, amount, and the like, the scope of the present technology is not necessarily limited to the number, amount, and the like unless otherwise stated particularly. Further, in the embodiments described below, each component is not necessarily essential to the present technology unless otherwise stated particularly.

Further, the present technology is not limited to one that necessarily exhibits all the functions and effects stated in the present embodiment.

It should be noted that in the present specification, the terms “comprise”, “include”, and “have” are open-end terms. That is, when a certain configuration is included, a configuration other than the foregoing configuration may or may not be included.

Also, in the present specification, when geometric terms and terms representing positional/directional relations are used, for example, when terms such as “parallel”, “orthogonal”, “obliquely at 45°”, “coaxial”, and “along” are used, these terms permit manufacturing errors or slight fluctuations. In the present specification, when terms representing relative positional relations such as “upper side” and “lower side” are used, each of these terms is used to indicate a relative positional relation in one state, and the relative positional relation may be reversed or turned at any angle in accordance with an installation direction of each mechanism (for example, the entire mechanism is reversed upside down).

In the present specification, the term “battery” is not limited to a lithium ion battery, and may include other batteries such as a nickel-metal hydride battery and a sodium-ion battery. In the present specification, the term “electrode” may collectively represent a positive electrode and a negative electrode.

In the present specification, the “battery” can be mounted on vehicles such as a hybrid electric vehicle (HEV), a plug-in hybrid electric vehicle (PHEV), and a battery electric vehicle (BEV). It should be noted that the use of the “battery cell” is not limited to the use in a vehicle.

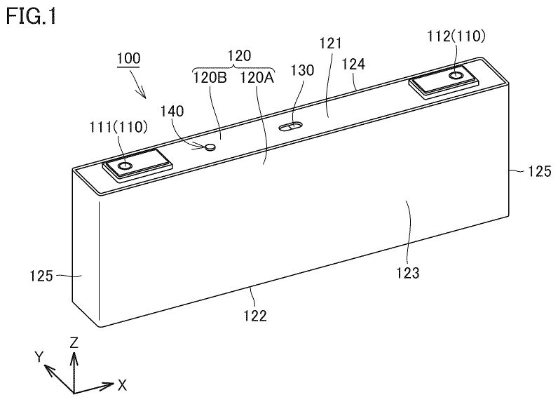

FIG. 1 is a perspective view of a battery included in a battery assembly. As shown in FIG. 1, a battery 100 (battery cell) has a prismatic shape. Battery 100 has electrode terminals 110, a housing 120, a gas-discharge valve 130, and an injection hole 140. A plurality of batteries 100 are arranged along a Y axis direction (first direction), thereby forming the battery assembly.

Electrode terminals 110 are formed on housing 120. Electrode terminals 110 have a positive electrode terminal 111 and a negative electrode terminal 112 arranged side by side along an X axis direction (second direction) orthogonal to the Y axis direction (first direction). Positive electrode terminal 111 and negative electrode terminal 112 are provided to be separated from each other in the X axis direction.

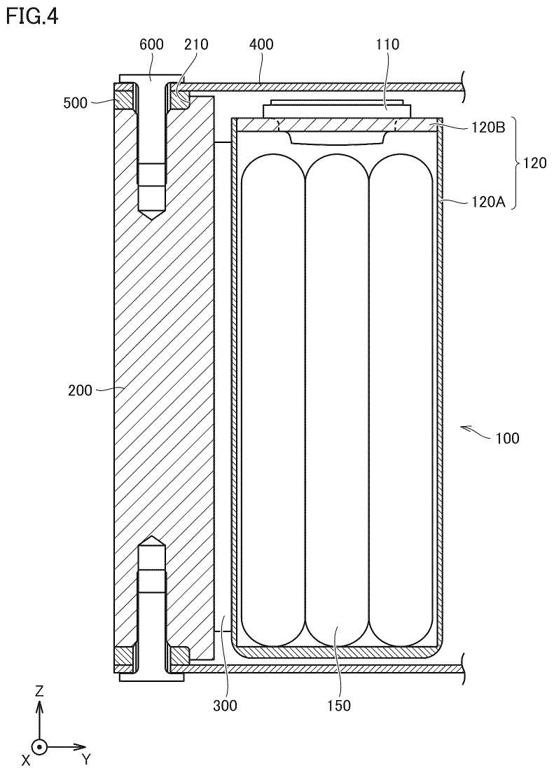

Housing 120 has a rectangular parallelepiped shape and forms an external appearance of battery 100. Housing 120 includes: a case main body 120A that accommodates an electrode assembly 150 (see FIG. 4) and an electrolyte solution; and a sealing plate 120B that seals an opening of case main body 120A. Sealing plate 120B is joined to case main body 120A by welding.

Housing 120 has an upper surface 121, a lower surface 122, a first side surface 123, a second side surface 124, and two third side surfaces 125.

Upper surface 121 is a flat surface orthogonal to a Z axis direction (third direction) orthogonal to the Y axis direction and the X axis direction. Electrode terminals 110 are disposed on upper surface 121. That is, in battery 100 illustrated in FIG. 1, each electrode terminal 110 is provided on a surface of housing 120 orthogonal to the Z axis direction (third direction). Lower surface 122 faces upper surface 121 along the Z axis direction.

Each of first side surface 123 and second side surface 124 is constituted of a flat surface orthogonal to the Y axis direction. Each of first side surface 123 and second side surface 124 has the largest area among the areas of the plurality of side surfaces of housing 120. Each of first side surface 123 and second side surface 124 has a substantially rectangular shape in which the X axis direction corresponds to the long-side direction and the Z axis direction corresponds to the short-side direction when viewed in the Y axis direction.

In one example, when the battery assembly is formed, batteries 100 adjacent to each other in the Y direction are stacked such that first side surfaces 123 of batteries 100 face each other and second side surfaces 124 of batteries 100 face each other. Thus, positive electrode terminals 111 and negative electrode terminals 112 are alternately arranged in the Y axis direction in which the plurality of batteries 100 are stacked.

Gas-discharge valve 130 is provided in upper surface 121. When the temperature of battery 100 is increased (thermal runaway) and internal pressure of housing 120 becomes more than or equal to a predetermined value due to gas generated inside housing 120, gas-discharge valve 130 discharges the gas to outside of housing 120.

Injection hole 140 is provided in upper surface 121. The electrolyte solution is injected into housing 120 through injection hole 140. Injection hole 140 is sealed by a sealing member. As the sealing member, for example, a blind rivet or another metal member can be used.

The positions of gas-discharge valve 130 and injection hole 140 are not limited to those shown in FIG. 1, and can be appropriately changed.

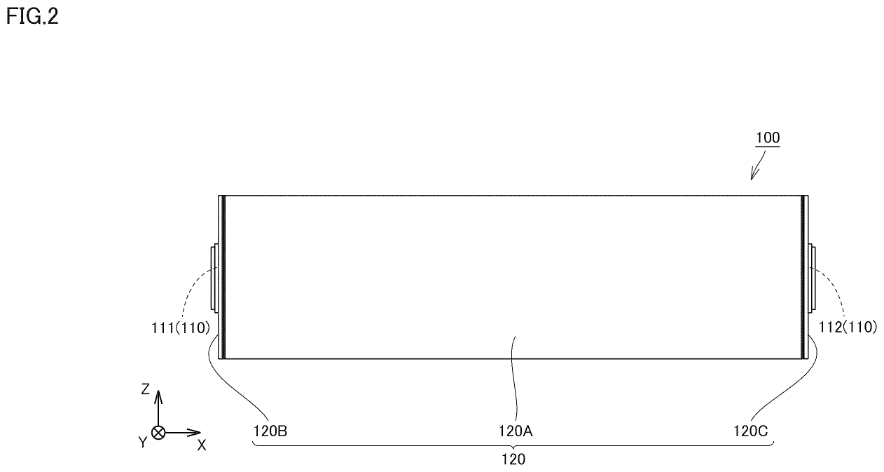

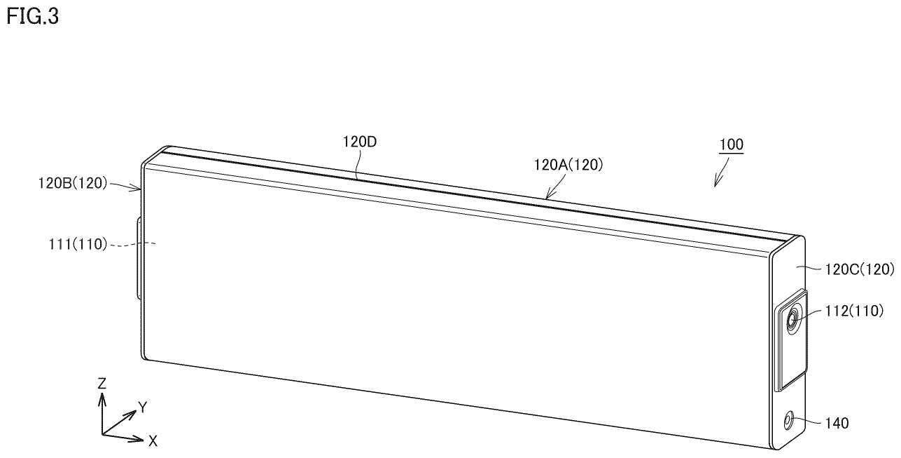

FIG. 2 is a front view showing a battery 100 according to a modification. FIG. 3 is a perspective view of battery 100 shown in FIG. 2. Battery 100 shown in FIGS. 2 and 3 is provided with electrode terminals 110, a housing 120, and an injection hole 140. A battery assembly is formed by arranging batteries 100 along the Y axis direction (first direction). Housing 120 includes a case main body 120A, a sealing plate 120B (first sealing plate), and a sealing plate 120C (second sealing plate). The plurality of batteries 100 are arranged along the Y axis direction (first direction), thereby forming the battery assembly.

Case main body 120A is constituted of a member having a tubular shape, preferably, a prismatic tubular shape. Thus, battery 100 having a prismatic shape is obtained.

As shown in FIGS. 2 and 3, sealing plate 120B and sealing plate 120C are provided at respective end portions of case main body 120A. Case main body 120A can be formed to have a prismatic tubular shape in, for example, the following manner: end sides of a plate-shaped member having been bent are brought into abutment with each other (joining portion 120D illustrated in FIG. 3) and are joined together (for example, laser welding). Each of the corners of the “prismatic tubular shape” may have a shape with a curvature.

Each of sealing plates 120B, 120C shown in FIGS. 2 and 3 has a substantially rectangular shape in which the Y axis direction corresponds to the short-side direction and the Z axis direction corresponds to the long-side direction. The substantially rectangular shape includes a rectangular shape or a generally rectangular shape such as a rectangular shape having corners each with a curvature.

Sealing plate 120B is provided with a positive electrode terminal 111. Sealing plate 120C is provided with a negative electrode terminal 112 and injection hole 140. That is, in battery 100 illustrated in FIGS. 2 and 3, each electrode terminal 110 is provided on a surface of housing 120 orthogonal to the X axis direction (second direction). The positions of positive electrode terminal 111, negative electrode terminal 112, and injection hole 140 can be appropriately changed.

In battery 100 shown in each of FIGS. 1 to 3, each of case main body 120A and sealing plates 120B, 120C is composed of a metal. Specifically, each of case main body 120A and sealing plates 120B, 120C is composed of aluminum, an aluminum alloy, iron, an iron alloy, or the like.

In battery 100 shown in each of FIGS. 1 to 3, case main body 120A is formed to be longer in the width direction (X axis direction) of battery 100 than in each of the thickness direction (Y axis direction) and the height direction (Z axis direction) of battery 100. That is, when battery 100 is viewed in the Y axis direction, housing 120 (case) of battery 100 has a substantially rectangular shape in which the X axis direction (second direction) corresponds to the long-side direction and the Z axis direction (third direction) corresponds to the short-side direction.

FIG. 4 is a diagram showing a restraint structure for battery 100 in the battery assembly according to the present embodiment. It should be noted that although battery 100 shown in FIG. 1 is illustratively shown in the example of the figure, the same structure as the restraint structure shown in FIG. 4 can also be applied to battery 100 shown in FIGS. 2 and 3.

As shown in FIG. 4, the battery assembly includes batteries 100, an end plate 200, a separator 300, a restraint member 400, contact plates 500, and bolts 600.

End plate 200 is provided at an end portion of the plurality of batteries 100 in the Y axis direction (first direction). When end plate 200 is viewed in the Y axis direction, end plate 200 has a substantially rectangular shape in which the X axis direction (second direction) corresponds to the long-side direction and the Z axis direction (third direction) corresponds to the short-side direction.

Separator 300, which has an insulating property, is provided between end plate 200 and battery 100. Separator 300 is also provided between the plurality of batteries 100. Restraint member 400 restrains end plate 200 and the plurality of batteries 100 in the Y axis direction.

Restraint member 400 includes a pair of plate-shaped members. As shown in FIG. 4, the pair of plate-shaped members are provided to sandwich the plurality of batteries 100 in the Z axis direction. Contact plates 500 are fixed to restraint member 400. Restraint member 400 and contact plates 500 are fixed to end plate 200 in the Z axis direction by bolts 600.

End plate 200 has stepped portions 210 on its both sides in the Z axis direction. Contact plates 500 are in abutment with stepped portions 210 in the Y axis direction. When the battery assembly is formed, the plurality of batteries 100 are held with the plurality of batteries 100 being compressed in the Y axis direction together with separators 300 by end plate 200. As a reaction, reaction force (cell reaction force) from battery 100 acts on end plate 200.

When expansion force is generated in battery 100, the expansion force causes increased force in the Y axis direction (cell reaction force) from battery 100. The cell reaction force is transmitted to restraint member 400 via stepped portion 210 of end plate 200 and contact plate 500. As a reaction, compression force in the Y axis direction is applied to battery 100, thereby suppressing expansion of battery 100.

By providing contact plate 500, the force (cell reaction force) in the Y axis direction from battery 100 can be supported as shear stress. It should be noted that restraint member 400 may be provided with a hole and contact plate 500 may be fitted into the hole to improve coupling strength between restraint member 400 and contact plate 500.

FIG. 5 is a diagram for illustrating a load acting on end plate 200. As described above, end plate 200 is coupled to restraint member 400 via contact plates 500 at the both ends in the Z axis direction, thereby restricting displacement in the Y axis direction.

As shown in FIG. 5, a load in the Y axis direction acts on end plate 200 from battery 100. Since the displacement in the Y axis direction is restricted at the both ends of end plate 200 in the Z axis direction, these portions are schematically regarded as two supporting points, and an interval therebetween can be defined as a distance (L) between the supporting points.

As shown in FIG. 5, assuming that the cell reaction force is a uniform distributed load (w), the maximum value (δmax) of an amount of deflection of end plate 200 due to the cell reaction force is schematically represented by
δmax=5wL⁴/384EI
(w: distributed load; L: distance between supporting points; E: Young's modulus; I: second moment of area),
and the maximum value (δmax) is proportional to the fourth power of the distance (L) between the supporting points.

As described above, end plate 200 has a function of suppressing deformation of battery 100. It has been required to suppress expansion of battery 100 by using end plate 200 so as to reduce deformation of housing 120.

In the present embodiment, since end plate 200 and restraint member 400 are coupled together at the both ends in the Z axis direction corresponding to the short-side direction of battery 100 when viewed in the Y axis direction, the distance (L) between the supporting points as shown in FIG. 5 can be smaller than that in a structure in which end plate 200 and restraint member 400 are coupled together at the both ends in the X axis direction corresponding to the long-side direction.

Therefore, in the present embodiment, when the distributed load (w) from the battery, the Young's modulus (E) of end plate 200, and the second moment of area (I) are unchanged, the maximum value (δmax) of the amount of deflection (amount of deformation) due to the cell reaction force can be small.

In other words, in the present embodiment, as long as a permissible amount of deformation of end plate 200 is unchanged, the amount of deformation at the time of receiving the predetermined distributed load (w) can satisfy a condition for the permissible amount of deformation even when the second moment of area (I) is relatively small.

The inventor of the present application has confirmed that, under a specific condition, the thickness of end plate 200 with which the amount of deformation at the time of receiving the same cell reaction force satisfies the condition for the permissible amount of deformation when end plate 200 is supported at the both ends in the short-side direction (Z axis direction) is less than ⅓ of that when end plate 200 is supported at the both ends in the long-side direction (X axis direction) (the thickness of about 60 mm becomes about 19 mm). By reducing the thickness of end plate 200, it is possible to reduce the size and weight of the battery assembly.

In the battery assembly according to the present embodiment, end plate 200 is restrained on the long side surface (side surface at each of the both ends in the Z axis direction) side of the battery assembly, rather than on the short side surface (side surface at each of the both ends in the X axis direction) side of the battery assembly, thereby suppressing the amount of deflection of end plate 200 from being excessively increased even when expansion force is generated in battery 100.

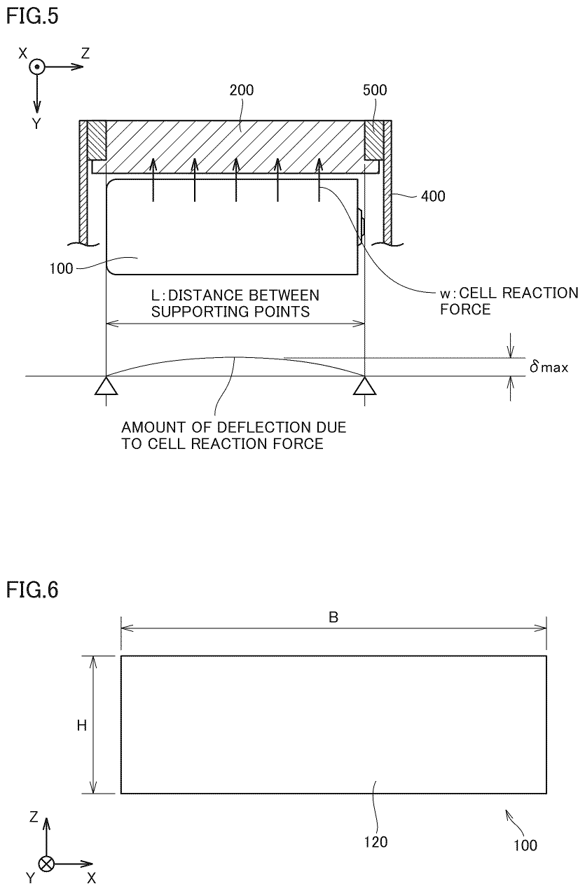

FIG. 6 is a diagram for illustrating a relation between the width (B) and height (H) of battery 100. As shown in FIG. 6, battery 100 included in the battery assembly according to the present embodiment has a substantially rectangular shape in which the width (B) in the X axis direction is larger than the height (H) in the Z axis direction. In other words, housing 120 of battery 100 has a substantially rectangular shape in which the X axis direction corresponds to the long-side direction and the Z axis direction corresponds to the short-side direction.

The dimension (width: B) of housing 120 in the X axis direction is preferably about 200 mm or more, is more preferably about 300 mm or more, and is further preferably about 500 mm or more. The dimension (width: B) of housing 120 in the X axis direction is preferably about 1200 mm or less. Since the dimension (width: B) of housing 120 in the X axis direction falls within the above range, battery 100 having a relatively large size (high capacity) can be formed.

The dimension (height: H) of housing 120 in the Z axis direction is preferably about 200 mm or less, is more preferably about 150 mm or less, is further preferably about 100 mm or less, and is, in one example, about 90 mm. Since the dimension (height: H) of housing 120 in the Z axis direction falls within the above range, (low-height) battery 100 having a relatively low height can be formed, thereby improving ease of mounting on a vehicle, for example.

A ratio (width/height: B/H) of the dimension of housing 120 in the X axis direction and the dimension of housing 120 in the Z axis direction is preferably about 2 or more, is more preferably about 3 or more, and is further preferably about 5 or more. The ratio (width/height: B/H) of the dimension of housing 120 in the X axis direction and the dimension of housing 120 in the Z axis direction is about 12 or less.

End plate 200 preferably has a dimension with which end plate 200 can be in abutment with the whole of each of first side surface 123 and second side surface 124 of housing 120. A ratio of the dimension of end plate 200 in the X axis direction and the dimension of end plate 200 in the Z axis direction may be substantially the same as the ratio of the dimension of housing 120 in the X axis direction and the dimension of housing 120 in the Z axis direction, or may be different therefrom. Moreover, the dimensions (width: B; height: H) of housing 120 and end plate 200 are not limited to the above numerical ranges.

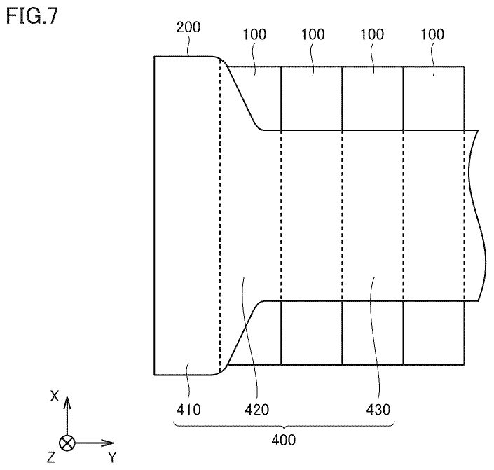

FIG. 7 is a diagram showing an exemplary shape of restraint member 400. In the example shown in FIG. 7, restraint member 400 includes: a first portion 410 having a relatively wide width in the X axis direction; a second portion 420 having a changing width in the X axis direction; and a third portion 430 having a relatively narrow width in the X axis direction. First portion 410, second portion 420, and third portion 430 are arranged from the end portion of the battery assembly in the Y axis direction toward the central portion thereof. That is, the dimension of restraint member 400 in the X axis direction is changed along the Y axis direction.

First portion 410 is fixed to end plate 200. Since first portion 410 having the wide width is disposed, the cross sectional rigidity of restraint member 400 can be large at the end portion of the battery assembly. Moreover, since second portion 420 that continuously changes the width of restraint member 400 between first portion 410 and third portion 430 is provided, occurrence of excessive stress concentration in restraint member 400 can be suppressed.

As shown in FIG. 7, restraint member 400 is preferably provided at a position including the center of the plurality of batteries 100 in the X axis direction (second direction) when viewed in the Z axis direction (third direction). Moreover, restraint member 400 preferably has a line-symmetric shape with respect to the axis in the Y axis direction (first direction) when viewed in the Z axis direction (third direction).

Although the embodiments of the present invention have been described and illustrated in detail, it is clearly understood that the same is by way of illustration and example only and is not to be taken by way of limitation. The scope of the present invention is defined by the terms of the claims, and is intended to include any modifications within the scope and meaning equivalent to the terms of the claims.

What is claimed is:

1. A battery assembly comprising:
a plurality of battery cells arranged in a first direction;
an end plate provided at an end portion of the plurality of battery cells in the first direction; and
a restraint member that restrains the end plate and the plurality of battery cells in the first direction, wherein
each of the plurality of battery cells includes a case that accommodates an electrode assembly and that has a substantially rectangular shape in which a second direction orthogonal to the first direction corresponds to a long-side direction and a third direction orthogonal to the first direction and the second direction corresponds to a short-side direction when viewed in the first direction,
the restraint member includes a pair of members provided to sandwich the plurality of battery cells in the third direction, and
the pair of members are fixed to the end plate in the third direction.

2. The battery assembly according to claim 1, wherein each of the plurality of battery cells has an electrode terminal on a surface of the case orthogonal to the third direction.

3. The battery assembly according to claim 1, wherein each of the plurality of battery cells has an electrode terminal on a surface of the case orthogonal to the second direction.

4. The battery assembly according to claim 1, wherein
the end plate has a stepped portion on at least one side in the third direction,
the battery assembly further comprising a contact plate fixed to the restraint member and in abutment with the stepped portion in the first direction.

5. The battery assembly according to claim 1, wherein each of the pair of members is constituted of a plate-shaped member.

6. The battery assembly according to claim 1, wherein
the end plate has a stepped portion on at least one side in the third direction,
the battery assembly further comprising a contact plate fixed to the restraint member and in abutment with the stepped portion in the first direction, wherein
each of the pair of members is constituted of a plate-shaped member.

7. The battery assembly according to claim 1, wherein each of the pair of members is provided at a position including a center of the plurality of battery cells in the second direction when viewed in the third direction.

8. The battery assembly according to claim 1, wherein
the end plate has a stepped portion on at least one side in the third direction,
the battery assembly further comprising a contact plate fixed to the restraint member and in abutment with the stepped portion in the first direction, wherein
each of the pair of members is constituted of a plate-shaped member, and
each of the pair of members is provided at a position including a center of the plurality of battery cells in the second direction when viewed in the third direction.

9. The battery assembly according to claim 1, wherein a dimension of each of the pair of members in the second direction is changed along the first direction.

10. The battery assembly according to claim 1, wherein
the end plate has a stepped portion on at least one side in the third direction,
the battery assembly further comprising a contact plate fixed to the restraint member and in abutment with the stepped portion in the first direction, wherein
each of the pair of members is constituted of a plate-shaped member,
each of the pair of members is provided at a position including a center of the plurality of battery cells in the second direction when viewed in the third direction, and
a dimension of each of the pair of members in the second direction is changed along the first direction.
